(19) United States
(12) Patent Application Publication
(10) Pub. No.: US 2009/0174325 A1
(43) Pub. Date: Jul. 9, 2009

(54) PIXELATED ELECTROLUMINESCENT TEXTILE

(75) Inventors: Michel Paul Barbara Van Bruggen, Eindhoven (NL); Martijn Krans, Eindhoven (NL); Adrianus Sempel, Eindhoven (NL); Sima Asvadi, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,470

(22) PCT Filed: Jun. 14, 2007
(86) PCT No.: PCT/IB2007/052254

§ 371 Date: Dec. 18, 2008

(30) Foreign Application Priority Data
Jun. 29, 2006 (EP) 06116267.3

(51) Int. Cl. H01J 1/62

(52) U.S. Cl. 313/505

(57) ABSTRACT

The present invention relates to a pixelated electroluminescent textile, comprising a first set of spaced apart conductive lines extending in a first direction, a second set of spaced apart conductive lines extending in a second direction, the second direction being non-parallel to the first direction, the sets of conducting lines forming a matrix structure, and at least one light emitting element. The at least one light emitting element comprises two interleaving comb electrodes arranged in one plane, and light emitting means arranged in spaces between digits of the comb electrodes, wherein the light emitting element is arranged in an area formed between two adjacent conductive lines in the first set and two adjacent conductive lines in the second set, wherein each of the comb electrodes connects to at least one yarn of the first and the second set, respectively, so that when applying a driving voltage to the at least one yarn in the first and second sets, said light emitting means is excited to emit light. It is according to the invention possible to generate light along each pair of comb digits. By arranging comb structures with multiple digits interleaved with each other in the area between four conducting lines, a light emitting element is achieved that can emit light in essentially this entire area.

### TECHNICAL FIELD

The present invention relates to a light-emitting textile, and more particularly to a pixelated electroluminescent textile.

### TECHNICAL BACKGROUND

There has been a recent development in relation to textiles with extended functionalities. For example, textiles can offer new functionalities such as textile control panels that can be integrated into the garment itself or in the textile product. Other new functionalities are light emitting textiles. Technically there are several solutions to creating light-emitting textiles depending on the kind of textile product involved. It is for example possible to weave light-emitting optic fibers in with the traditional fibers, or use conductive threads to integrate LEDs. The light can furthermore be emitted from the textiles by use of electro-optic (EO) materials deposited onto conductive yarns, or EO materials deposited onto fabrics.

It is for example possible to electrically address EO material by use of two sets of orthogonal conducting fibers of which the first set contains the anode electrodes and the second set contains the cathode electrodes. The two sets of electrodes do not make direct electrical contact with each other. The structure as such can be used as a passive matrix element. The electrode structure may comprise EO coated conducting yams that may consist of separated conducting transparent outer shells, or the fiber matrix might be impregnated by an EO substance. All electrical fields engendered are orthogonal to the fabric.

An example of such a light modulating textile device is disclosed in U.S. Pat. No. 6,072,619. In one embodiment, the light modulating device comprises a first set of fibers and a second set of fibers arranged to form a two dimensional array of junctions between fibers belonging to the different sets. Each of the fibers includes a longitudinal conductive element, and fibers in at least one of the sets further include, at least at the junctions, a coat of an electro-optically active substance being capable of reversibly changing its optical behavior when subjected to an electric field. Hence, when a drive voltage is applied to the sets of conductive fibers, the electro-optically active substance is exited, thereby emitting light at the junctions between the sets of fibers. However, the problem with this approach is that it is difficult to make pixels with sizes largely exceeding the diameter of the conductive fibers/yarns.

### SUMMARY OF THE INVENTION

There is therefore a need for an improved electroluminescent textile, substantially overcoming at least some of the disadvantages of the prior art, and more specifically that overcomes or at least alleviates the problem of limited pixel size in a electroluminescent textile.

According to a first aspect of the invention, this and other objects are achieved by providing a pixelated electroluminescent textile, comprising a first set of spaced apart conductive lines extending in a first direction, a second set of spaced apart conductive lines extending in a second direction, the second direction being non-parallel to the first direction, the sets of conducting lines forming a matrix structure, and at least one light emitting element. The at least one light emitting element comprises two interleaving comb electrodes arranged in one plane, and light emitting means arranged in spaces between digits of the comb electrodes, wherein the light emitting element is arranged in an area formed between two adjacent conductive lines in the first set and two adjacent conductive lines in the second set, wherein each of the comb electrodes connects to at least one yarn of the first and the second set, respectively, so that when applying a driving voltage to the at least one yarn in the first and second sets, said light emitting means is excited to emit light.

According to the invention, it is thus possible to generate light along each pair of comb digits, i.e. the light generation will take place along a line instead of in a point (yarn junction). By arranging comb structures with multiple digits interleaved with each other in the area between four conducting lines, a light emitting element is achieved that can emit light in essentially this entire area.

Preferably, the light emitting means is an electroluminescent material, so that, when the driving voltage is applied, a voltage difference is created in the spaces along the digits of the comb electrodes, which thereby will excite the electroluminescent material in the spaces. This embodiment of the invention is advantageous since it thereby will be possible to use for example an electroluminescent material (for instance impregnated in the fabric) in between the comb electrodes. Alternatively, it would also be possible to use a light emitting diode (LED) as the light emitting means, wherein the comb structure will provide for the possibility to integrate a plurality of LEDs in one light-emitting element.

The distance separating the digits of the comb electrodes can be in the range of 50-200 microns. Such separation distances will allow the voltage difference to be less than 100 V, and still achieve the required electrical field between the digits. A moderate voltage is considered advantageous, in order to make the textile suitable for various applications.

The digits of the comb electrodes preferably have a diameter that is less than 50 microns, in order to obtain a relationship between the mentioned separation distance (L1) and the diameter (L2) greater than 1.

The light-emitting element can be addressed using passive matrix addressing or active matrix addressing. In the latter case, a third and a fourth set of spaced apart conductive lines are required, and the light emitting element comprises a switching IC connected to lines in said third and fourth sets, respectively, and to one of the comb structures. The third and the fourth set of lines can then provide a data and a select signal to the switching IC, thereby allowing active matrix control of the light-emitting element.

According to a preferred embodiment, the light-emitting element comprises at least two sets of different cathode comb electrodes and one set of anode comb electrodes, thereby forming a light-emitting element adapted to emit light of at least two colors.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

These and other aspects of the present invention will now be described in more detail, with reference to the appended drawings showing currently preferred embodiment of the invention.

FIG. 1a illustrates a structural diagram/cross section of a part of a passive pixelated electroluminescent textile according to a preferred embodiment of the invention.

FIG. 1b illustrates a detailed view of a part of the passive pixelated electroluminescent textile as depicted in FIG. 1a.

FIG. 2a illustrates a structural diagram/cross section of a part of an active pixelated electroluminescent textile according to another preferred embodiment of the invention.

FIG. 2b illustrates a detailed view of a switching IC for the active pixelated electroluminescent textile as depicted in FIG. 2a.

FIG. 3 illustrates an alternative embodiment of a light-emitting element.

### DETAILED DESCRIPTION OF THE PREFERRED EMBODIMENTS

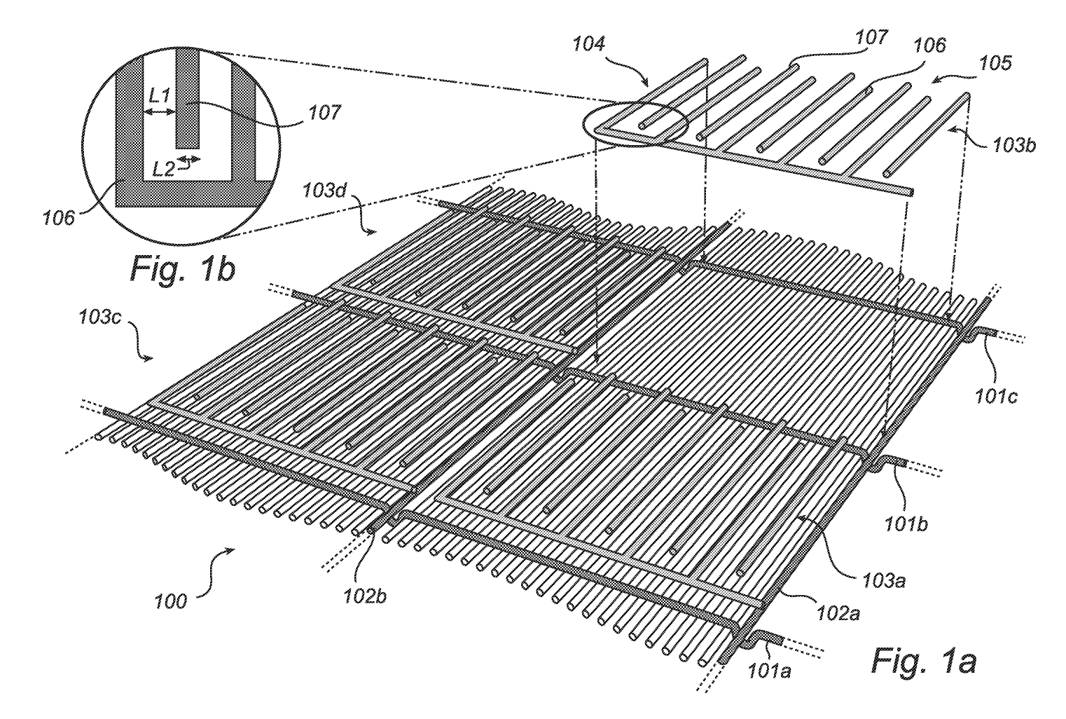

In FIG. 1a, a structural diagram/cross section of a part of a pixelated electroluminescent textile 100 according to a currently preferred embodiment of the invention is shown.

The pixelated electroluminescent textile 100 comprises a plurality of spaced apart conductive lines 101a-c extending in a first direction, and a second plurality of spaced apart conductive lines 102a-b extending in a second direction. In the areas formed between pairs of conductive lines 101 and 102, light emitting elements 103a-d are formed. The light emitting elements 103a-d comprises a first 104 and a second 105 comb electrode, each having digits 106 and 107 that interleaves with each other in one plane. In the spaces along the digits 106 and 107, a electroluminescent material is arranged. As an illustrated example, the first comb electrode 104 of the light element 103a, is connected to line 102b and its second comb electrode 105 in turn connects to the line 101b.

In figure la, only four light emitting elements 103a-d are illustrated, however, the person skilled in the art realizes that the pixelated electroluminescent textile 100 may comprise a large plurality of light emitting elements 103.

The light elements 103, as illustrated, have been printed onto the textile itself. However, it would also be possible to arranged the light elements 103 as separate pieces of woven fabric (like a quilt), and sew or embroider these quilts onto the woven basic structure.

It would furthermore be possible to weave a fabric comprising lines and/or yarns having the same functionality as the light emitting elements 103 described above in relation to FIG. 1a. However, arrays of comb electrodes cannot be woven in one single step. To obtain unconnected comb electrode areas it is required that the comb electrodes weft and warp yarns are unconnected when going from the one to the other electrode area. This could be done by for example laser etching. However, when the pixelated electroluminescent textile 100 has A number of rows and B number of columns and each comb electrode area consists of C yarns, the number of cuts N will be (A−1)×B×C+(B−1)×A. For example, if A and B are equal to 100 and C is equal to 10, N becomes about 10⁵. Therefore, from a production point of view, it is more attractive to print the conducting comb structure onto the textile. On the other hand, the conductive lines extending in the first and second direction does not necessarily have to be made from conductive yarns, but could also be conducting lines on fabrics made by printing or etching.

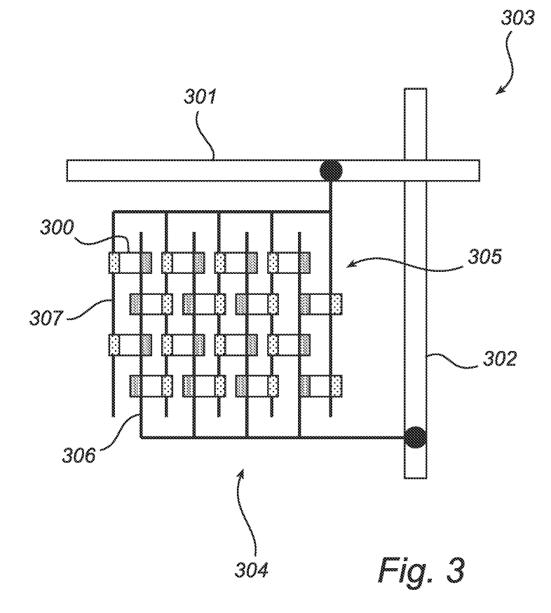

In FIG. 1a, the first comb electrode 104 has been illustrated as an integrated structure comprising a plurality of digits 106 with only one connection point to the conducting line, while the second comb electrode 105 has been illustrated as a plurality of separate digits 107. As understood by the person skilled in the art, both comb electrodes 104 and 105 may be of similar design. For example, and as illustrated in FIG. 3 in relation to a different embodiment, both comb electrodes can consist of integrated structures, each with only one connection point.

Furthermore, during operation, a driving voltage is applied to the lines 102 and 103, wherein a voltage difference is created in the spaces along the digits 106 and 107 of the comb electrodes 104 and 105 of the light elements 103, thereby exciting the electroluminescent material arranged in between the digits 106 and 107.

In FIG. 1b, a detailed view of a part of a light-emitting element is depicted. As the excitation of the electroluminescent material is a process determined by an electrical field, the dimensions between the comb electrodes determine the driving voltage. The dimensions of the comb electrode structures is preferably adapted such that only moderate voltages are required to excite the electroluminescent material. The distance L1 is typically within the range of 50-200 micron, to prevent the driving voltage to exceed for example 100 volts. This distance L1 may for example be achieved by in between two adjacent electrodes weave in an appropriate number of n insulating yarns, each having a well-defined diameter d, so that n×d yields the required value for L1. The driving frequency is preferably within the range of tens to thousands of Hertz. To optimize the brightness of the light emitting elements 103, a ratio L1/L2 should as large as possible, preferably much larger than 1. Given the above, the diameter of the digits of the electrode combs should be preferably smaller than 50 microns.

The textile in FIG. 1 is a passive matrix textile. Similar to LCDs, pixelated electroluminescent textile come in both passive matrix and active matrix configurations. In a passive matrix textile, the light emitting elements are connected in a grid. The rows of the grid are lit one at a time using external drive circuitry. In contrast, active matrix textiles include transistors within the matrix textile enabling light emitting elements to be continuously illuminated.

Although it is straightforward, passive matrix technology does have some shortcomings. For one, refresh times are relatively slow. Also, there is a tendency for the voltage field at a row-column intersection to bleed over into neighboring pixels.

However, active-matrix technology, using an IC-like manufacturing process, is a considerable improvement. Each pixel may have a capacitor, to retain charge between refresh cycles, and a transistor switch. The current drawn in controlling a given light emitting element is reduced, so light emitting elements of the passive pixelated electroluminescent textile can be switched at a faster rate, leading to faster refresh rates compared to passive displays.

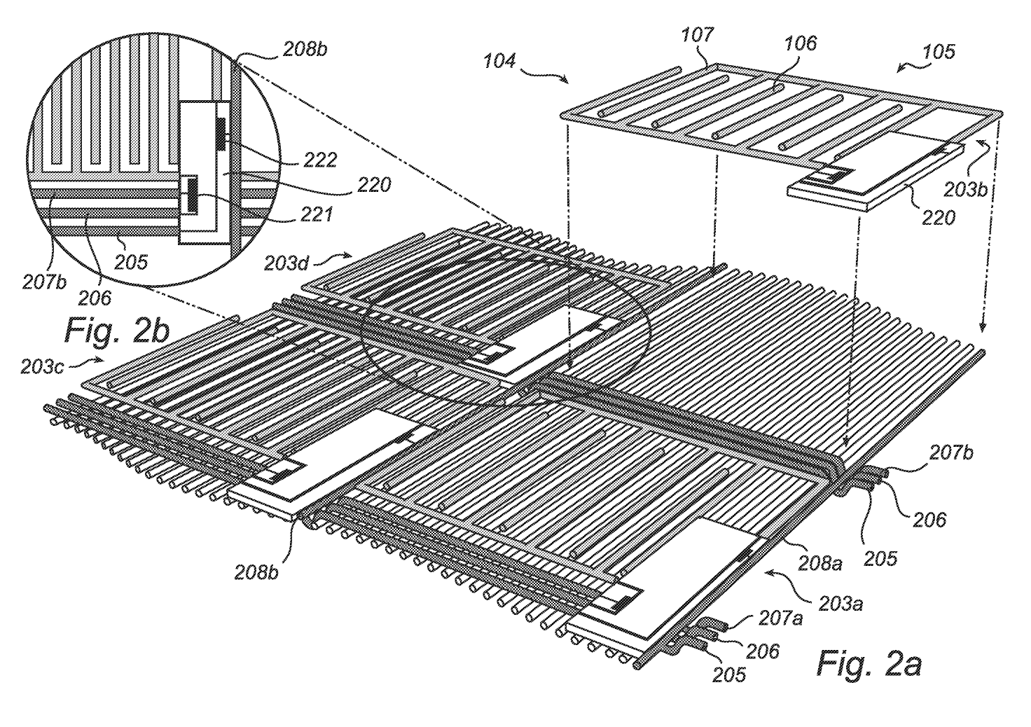

In FIG. 2a, a structural diagram/cross section of a part of a pixelated electroluminescent textile 200 according to a second embodiment of the invention is shown.

The construction and functionality of light elements 203a-d are generally the same as the light elements 103a-d in FIG. 1a, however, as the pixelated electroluminescent textile 200 is an active pixelated electroluminescent textile, each of the light elements 203a -d further comprises a switching IC 220. The pixelated electroluminescent textile 200 furthermore comprises a third and a fourth set of spaced apart conductive lines 207a-b and 208a-b, adapted to provide a data and a select signal to the switching IC, respectively. Furthermore, as in FIG. 1a, the pixelated electroluminescent textile 200 comprises first 205 and second 206 plurality of conductive lines, adapted to provide a drive voltage to the pixelated electroluminescent textile 200.

FIG. 2b illustrates a detailed view of the switching IC 220 light emitting element 203d. As can be seen, the switching IC 220 is comprised of a first 221 and a second 222 transistor. The transistors 221, 222 acts as control and/or hold circuits for each of the light elements 203a-d. The first transistor 221 connects to both the first conductor 205, which is providing the drive voltage, and the select line 207b. The second transistor 222 connects to the second conductor 206, which is providing the drive voltage, and the data line 208b.

During operation, a driving voltage is applied to the lines 205 and 206. When a control voltage is connected to both the select line 207b and the data line 208b, the transistors 221, 222 opens, and the comb electrode is set to the drive voltage of the lines 205 and 205, wherein an electroluminescent material arranged in between the digits 106 and 107 of the comb electrodes 104 and 105 is excited, thereby emitting light.

FIG. 3 illustrated an alternative embodiment of a light emitting element 304, wherein a plurality of light emitting diodes, LEDs, 300 have been connected to the digits 306 and 307 of the comb electrodes 304 and 305, respectively. The comb electrodes 304 and 305 in turn connects to the conductive lines 301 and 302. As can be see, the anode terminals of the LEDs are all connected to the comb electrode 304, and the cathode terminals of the LEDs all connects to the comb electrode 305.

Furthermore, it would be possible to combine a plurality of differently colored LEDs arranged to emit light having a color mixture. For this purpose, LED packages containing multiple LEDs, possibly also with multiple colors (e.g. R, G, B), and/or LED packages containing single LEDs with various colors (e.g. R, G, B) can be used.

As described above in relation to the operation of the light emitting elements in FIG. 1 and 2, the LEDs 300 are exited to emit light when a driving voltage is applied to the conductive lines 301 and 302.

The person skilled in the art realizes that the present invention by no means is limited to the preferred embodiments described above. On the contrary, many modifications and variations are possible within the scope of the appended claims. For example, FIGS. 2a and b illustrates a situation in which every light-emitting element each is switched by one separate IC. However, it might be more efficient to drive more than one pixels per switching IC, or depending on the kind of images that are created, one switching IC per row might be sufficient.

Furthermore, each light-emitting element may comprises more than two interleaving comb electrodes, for example two or more different cathode comb electrodes and one anode comb electrode. With such an arrangement, it is possible to adapt the pixelated electroluminescent textile to emit light of two or more colors. This can be useful for example when having LEDs with different colors in the embodiment illustrated in FIG. 3.

Further, both in the passive configuration, as described above in relation to FIG. 1, and in the active configuration as described in relation to FIG. 2, an electrical connection between the comb electrodes in the light emitting elements and the sets of conductive lines in the fabric can be made by using conductive glue or soldering. In the case of an active matrix configuration, a snap button like connection method could also be of interest, as in this case the electrical components needed in the active light emitting elements could be arranged together with the snap button.

1. A pixelated electroluminescent textile, comprising:
a first set of spaced apart conductive lines extending in a first direction;
a second set of spaced apart conductive lines extending in a second direction, said second direction being non-parallel to the first direction, said sets of conducting lines forming a matrix structure; and
at least one light emitting element comprising two interleaved comb electrodes arranged in one plane; and light emitting means arranged in spaces between digits of said comb electrodes,
wherein said light emitting element is arranged in an area formed between two adjacent conductive lines in said first set and two adjacent conductive lines in said second set, and
wherein a first of said comb electrodes is connected to at least one line of said first set, and a second of said comb electrodes is connected to at least one line of said second set, so that, when a driving voltage is applied to said at least one line in said first set and said at least one line in said second set, said light emitting means is excited to emit light.

2. A pixelated electroluminescent textile according to claim 1, wherein said light emitting means is an electroluminescent material, so that, when said driving voltage is applied, a voltage difference is created in the spaces along said digits of said comb electrodes, thereby exciting said electroluminescent material in said spaces.

3. A pixelated electroluminescent textile according to claim 1, wherein said light emitting means is a light emitting diode (LED).

4. A pixelated electroluminescent textile according to claim 1, wherein a separating distance between the digits of said comb electrodes is in the range of 50-200 microns.

5. A pixelated electroluminescent textile according to claim 1, wherein the digits of said comb electrodes have a diameter that is less than 50 microns.

6. A pixelated electroluminescent textile according to claim 1, wherein the pixelated electroluminescent textile is adapted to address said light emitting element using active matrix addressing.

7. A pixelated electroluminescent textile according to claim 1, further comprising:
a third and a fourth set of spaced apart conductive lines; and wherein said light emitting element further comprises:
a switching IC connected to yarns in said third and fourth sets, respectively, and to one of said comb structures,
wherein the third and the fourth set of yarns provide a data and a select signal to said switching IC, respectively, thereby allowing active matrix control of said light emitting element.

8. A pixelated electroluminescent textile according to claim 1, wherein the two sets of lines are adapted to address said light emitting element using passive matrix addressing.

9. A pixelated electroluminescent textile according to claim 1, wherein the light emitting element comprises at least two sets of different cathode comb electrodes and one set of anode comb electrodes, thereby forming a light emitting element adapted to emit light of at least two colors.
